(19) United States
(12) Patent Application Publication
(10) Pub. No.: US 2023/0033020 A1
(43) Pub. Date: Feb. 2, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi, Aichi-ken (JP)

(21) Appl. No.: 17/856,633

(22) Filed: Jul. 1, 2022

(30) Foreign Application Priority Data
Jul. 27, 2021 (JP) 2021-122684

(51) Int. Cl. G01N 21/84

(52) U.S. Cl. CPC G01N 21/8422; G01N 2021/8427; G01N 2201/0216

(57) ABSTRACT

An information processing apparatus includes a controller configured to execute first processing of providing an incentive to a first user who brings a first painting film to a predetermined base. The first painting film is a painting film including an easily peeling layer and that is peeled off from a first vehicle.

### CROSS-REFERENCE TO RELATED APPLICATION

This application claims priority to Japanese Patent Application No. 2021-122684 filed on Jul. 27, 2021, incorporated herein by reference in its entirety.

### BACKGROUND

### 1. Technical Field

The present disclosure relates to an information processing apparatus, an information processing method, and a non-transitory storage medium.

### 2. Description of Related Art

A technology for applying strippable paint on a painted surface when, for example, transporting a vehicle on which painting has been completed is well-known (see, for example, Japanese Unexamined Patent Application Publication No. 6-142604).

### SUMMARY

The present disclosure provides an efficient technology for processing of appropriately disposing of a painting peeled off from a vehicle.

A first aspect of the present disclosure is an information processing apparatus including a controller configured to execute first processing of providing an incentive to a first user who brings a first painting film to a predetermined base. The first painting film is a painting film including an easily peeling layer and that is peeled off from a first vehicle.

In the first aspect, the first processing may include acquiring first information including information on a first weight, which is a weight of the first painting film brought to the predetermined base, and calculating the incentive to be provided to the first user based on the first information.

In the first aspect, the first information may include information on the first weight and information on a size of a first part, which is a part from which the first painting film is peeled off in the first vehicle. The controller may configured to calculate, based on the size of the first part, a first estimation value, which is a weight of the first painting film estimated to have been applied on the first part, and calculate the incentive such that the incentive becomes higher as a ratio of the first weight to the first estimation value is greater.

In the first aspect, the controller may configured to correct the incentive that is calculated based on the first information such that the incentive becomes higher when the first user provides additional information to the predetermined base than when the first user does not provide the additional information. The additional information may be information on peeling-off of the first painting film from the first vehicle.

In the first aspect, the additional information may include an image of the first vehicle before the first painting film is peeled off and an image of the first vehicle after the first painting film is peeled off.

In the first aspect, the additional information may include an image of an original painting in a part from which the first painting film is peeled off in the first vehicle.

In the first aspect, the additional information may include information on a timing at which the first painting film is peeled off.

In the first aspect, the additional information may include information on a reason why the first painting film is peeled off.

In the first aspect, the additional information may include information on a method of peeling off the first painting film when the first user intentionally peels off the first painting film.

In the first aspect, the additional information may include information on a time needed for peeling off the first painting film when the first user intentionally peels off the first painting film.

A second aspect of the present disclosure is an information processing method executed by a computer. The information processing method includes executing first processing of providing an incentive to a first user who brings a first painting film to a predetermined base. The first painting film includes an easily peeling layer and that is peeled off from a first vehicle.

In the second aspect, the first processing may include acquiring first information including information on a first weight, which is a weight of the first painting film brought to the predetermined base and calculating the incentive to be provided to the first user based on the first information.

In the second aspect, the first information may include information on the first weight and information on a size of a first part, which is a part from which the first painting film is peeled off in a first vehicle. The first processing may include calculating a first estimation value, which is a weight of the first painting film estimated to have been applied on the first part, based on the size of the first part, and calculating the incentive such that the incentive becomes higher as a ratio of the first weight to the first estimation value is greater.

In the second aspect, the first processing includes correcting the incentive that is calculated based on the first information such that the incentive to be provided to the first user becomes higher when the first user provides additional information on peeling-off of the first painting film from the first vehicle to the predetermined base than when the first user does not provide the additional information.

In the second aspect, the additional information may include an image of the first vehicle before the first painting film is peeled off and an image of the first vehicle after the first painting film is peeled off.

In the second aspect, the additional information may include an image of an original painting in a part from which the first painting film is peeled off in the first vehicle.

In the second aspect, the additional information may include information on a timing at which the first painting film is peeled off.

In the second aspect, the additional information may include information on a reason why the first painting film is peeled off.

In the second aspect, the additional information may include information on a method of peeling off the first painting film when the first user intentionally peels off the first painting film.

A third aspect of the present disclosure is a non-transitory storage medium that causes the computer to execute the information processing method.

With each aspect of the present disclosure, it is possible to provide an efficient technology for processing of appropriately disposing of a painting peeled off from a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating an overview of a vehicle management system according to an embodiment;

FIG. 2 is a diagram illustrating a first configuration example of a painting film applied on a first vehicle;

FIG. 3 is a diagram illustrating a second configuration example of the painting film applied on the first vehicle;

FIG. 4 is a diagram illustrating respective hardware configuration examples of a server apparatus and a base terminal included in the vehicle management system according to the embodiment;

FIG. 5 is a block diagram illustrating a functional configuration example of the server apparatus according to the embodiment;

FIG. 6 is a diagram used for describing a method of determining a coefficient according to the embodiment;

FIG. 7 is a flowchart illustrating a processing routine executed in the server apparatus according to the embodiment; and

FIG. 8 is a flowchart illustrating a subroutine executed in the server apparatus according to the embodiment.

### DETAILED DESCRIPTION OF EMBODIMENTS

A technology for applying painting that can be peeled off on the body of a vehicle using a painting film (a first painting film) including an easily peeling layer has been developed. The first painting film is a peelable painting film and is applied by being topcoated on an original painting applied on the body at the time of, for example, manufacturing of a vehicle. In the original painting, an electrodeposition layer (an undercoat) is formed on the surface of a steel plate or the like composing the body of the vehicle, and an intermediate coat layer, a base layer, a clear layer (a topcoat), and the like are laminated on the electrodeposition layer. Since a special solution, such as a release agent, is needed to peel off the original painting, it is difficult to easily peel off the original painting. On the other hand, the first painting film is a combination of, for example, an easily peeling layer formed on the original painting and a painting film (for example, a base layer and a clear layer) formed on the easily peeling layer. The first painting film can be easily peeled off by applying a force even without using a special solvent. In the first painting film, the painting film itself may be peelable (an easily peeling paint).

As above, since the first painting film can be easily peeled off, the body color can be changed at any timing. For example, when purchasing or leasing a vehicle, an original painting having a color that is popular in a used car market and the like can be selected, and then a first painting film having a color different from that of the original painting can be applied for use of the vehicle. Then, when selling or returning the vehicle, the body color can also be returned to the color of the original painting by peeling off the first painting film. As such, in a case where, for example, a color that is popular in the used car market and the like differs from a color that the user likes, it is possible to fulfil a need of the user while ensuring a resale value. Further, it is also possible to change the appearance of the vehicle by peeling off the first painting film during use of the vehicle.

Since it is easier to peel off the first painting film as above than the original painting, it is also assumed that the first painting film is peeled off while the vehicle is being used. Further, it is also assumed that the user intentionally peels off the first painting film. In these cases, it is desirable to execute processing of appropriately disposing of the first painting film peeled off from the vehicle.

Therefore, in the information processing apparatus according to the present disclosure, a controller executes processing (first processing) of providing an incentive to the user (a first user) who brings the first painting film peeled off from the first vehicle to a predetermined base. Here, the “predetermined base” is a base at which work or procedures of appropriately disposing of the first painting film peeled off from the first vehicle can be executed, and may be, for example, a car dealer cooperating with a manufacturer of the first vehicle, or a maintenance shop. With the present disclosure, the first user can receive a provision of an incentive in return for bringing the first painting film peeled off from the first vehicle to the predetermined base. As a result, it is possible to motivate the first user to bring the first painting film peeled off from the first vehicle to the predetermined base. Therefore, it is also possible to execute the processing of appropriately disposing of the first painting film peeled off from the first vehicle.

The “first painting film peeled off from the first vehicle” includes a first painting film that has been peeled off against the will of the first user and a first painting film that has been intentionally peeled off by the first user.

In the information processing apparatus according to the present disclosure, as the first processing, the controller may acquire first information including information on a first weight, which is a weight of the first painting film brought to the predetermined base, and calculate, based on the first information, the incentive to be provided to the first user. In this case, the incentive to be provided to the first user can be determined according to the weight (the first weight) of the first painting film brought to the predetermined base. As such, for example, it is possible to motivate the first user to bring, to the predetermined base, as many first painting films as possible from among the first painting films peeled off from the first vehicle. As a result, it is possible to further increase amounts of the first painting films that are appropriately disposed of from among the first painting films that have been peeled off from the first vehicle.

Here, in addition to the information on the first weight, the first information may include information on a size of a first part, which is a part from which the first painting film has been peeled off in the first vehicle. In that case, based on the size of the first part, the controller of the information processing apparatus can also calculate a first estimation value, which is the weight of the first painting film estimated to have been applied on the first part. Further, the controller of the information processing apparatus can also calculate the incentive such that it becomes higher as a ratio of the first weight to the first estimation value is greater. As such, it is easy to motivate the first user to bring, to the predetermined base, as many first painting films as possible from among the first painting films peeled off from the first vehicle.

Further, the controller of the information processing apparatus may correct the incentive, which is calculated based on the first information, such that the incentive to be provided to the first user becomes higher when the first user provides, to the predetermined base, additional information on peeling-off of the first painting film from the first vehicle than when the first user does not provide it. As such, when bringing the first painting film peeled off from the first vehicle to the predetermined base, it is also possible to motivate the first user to provide the additional information to the base. As a result, it is also possible for the predetermined base, a manufacturer cooperating with the predetermined base, or the like to more accurately manage a history and the like on the painting of the first vehicle.

Here, the additional information may include an image of the first vehicle before the first painting film has been peeled off and an image of the first vehicle after the first painting film has been peeled off. In that case, by comparing the images of the first vehicle before and after the first painting film has been peeled off, it is also possible to specify a region from which the first painting film has been peeled off, or to check a size of the part (a first part) from which the first painting film has been peeled off. Further, by comparing the images of the first vehicle before and after the first painting film has been peeled off, it is also possible to more accurately determine whether the first painting film brought to the predetermined base has been peeled off from the first vehicle.

Further, the additional information may include an image of the original painting in the part from which the first painting film has been peeled off in the first vehicle. As such, it is also possible to more accurately manage a state of the original painting of the first vehicle. As a result, when, for example, selling or returning the first vehicle, it is also possible to more accurately assess the resale value of the first vehicle.

Further, the additional information may include information on the timing at which the first painting film has been peeled off. As such, it is also possible to more accurately manage a history on the topcoat painting of the first vehicle.

Further, the additional information may include information on a reason why the first painting film has been peeled off. As such, it is also possible to more accurately grasp a cause and the like of the peeling-off of the first painting film. For example, it is also possible to specify by what cause the first painting film can be peeled off except when the first user has intentionally peeled off the first painting film, and execute, for example, an improvement of the first painting film according to the specified cause.

Further, when the first user has intentionally peeled off the first painting film, the additional information may include information on a method of peeling off the first painting film. As such, it is also possible to manage how the first painting film applied on the first vehicle has been peeled off.

Further, when the first user has intentionally peeled off the first painting film, the additional information may include information on a time needed for peeling off the first painting film. As such, it is also possible for a general user to grasp a time needed for peeling off the first painting film with his/her own hands.

### EMBODIMENTS

Hereinafter, specific embodiments of the present disclosure will be described with reference to drawings. Unless otherwise specified, the configurations described in the present embodiments are not intended to limit the technical scope of the present disclosure only thereto.

In the present embodiment, an example where the information processing apparatus according to the present disclosure is applied to a system (hereinafter, sometimes referred to as a “vehicle management system”) that manages a vehicle on which a topcoat painting is applied will be described.

Overview of System

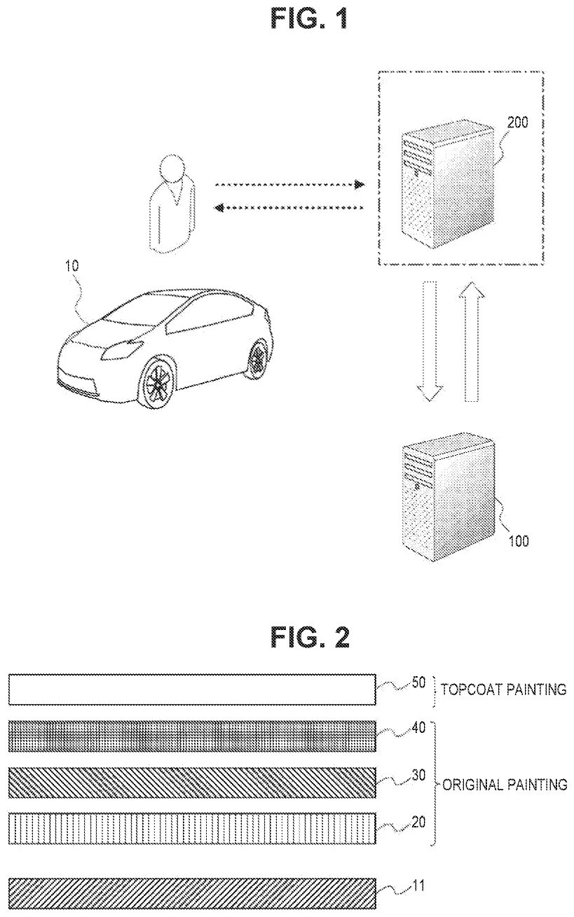

FIG. 1 is a diagram illustrating an overview of the vehicle management system to which the information processing apparatus according to the present disclosure is applied. The vehicle management system in the present embodiment includes a server apparatus 100 and a base terminal 200. In an example illustrated in FIG. 1, only one first vehicle 10 under a control of the server apparatus 100 is shown, but the number of first vehicles 10 under the control of the server apparatus 100 may be plural. Further, in the example illustrated in FIG. 1, only one base terminal 200 is shown, but the number of base terminals 200 may be plural.

The server apparatus 100 is operated by a business operator who manages a vehicle (a first vehicle) 10 on which a topcoat painting is applied. The business operator who operates the server apparatus 100 may be, for example, the manufacturer of the first vehicle 10, or a business operator cooperating with the manufacturer. When work of taking over the topcoat painting peeled off from the first vehicle 10 is executed at the predetermined base, the server apparatus 100 of the present embodiment executes various processes used for providing the incentive to the user (the first user) who brings the topcoat painting. In the present embodiment, the “topcoat painting” is a peelable painting film that is applied by being topcoated on the original painting applied on the body at the time of manufacturing and the like of the first vehicle 10, and is one example of the “first painting films” according to the present disclosure. The details of the topcoat painting will be described below.

When the work of taking over the topcoat painting peeled off from the first vehicle 10 is executed at the predetermined base, the server apparatus 100 calculates the incentive based on the first information provided from the base terminal 200, and requests the base terminal 200 to provide the calculated incentive to the first user (hereinafter, sometimes referred to as a “provision request”). In the present embodiment, the “topcoat painting peeled off from the first vehicle 10” includes a topcoat painting peeled off from the first vehicle 10 against the will of the first user, and a topcoat painting intentionally peeled off from the first vehicle 10 by the first user. Further, in the present embodiment, the “first information” includes information on a weight (the first weight) of the topcoat painting brought to the predetermined base, and information on a size (an area) of the part (the first part) from which the topcoat painting has been peeled off in the first vehicle 10.

The base terminal 200 is used at the predetermined base at which the work of taking over the topcoat painting peeled off from the first vehicle 10 is executed. The base terminal 200 of the present embodiment is used by an employee of the predetermined base at which the work of taking over the topcoat painting peeled off from the first vehicle 10 is executed. In the present embodiment, the “predetermined base” is a base at which work or procedures of appropriately disposing of the topcoat painting taken over from the first user can be executed. At such a predetermined base, when the work of taking over the topcoat painting brought by the first user is executed, the base terminal 200 receives an input of the first information and provides the received first information to the server apparatus 100. The input of the first information is executed by the employee of the predetermined base. Further, upon receiving the provision request from the server apparatus 100, the base terminal 200 presents the provision request to the employee of the predetermined base. The employee who receives such a presentation can carry out procedures of providing the incentive to the first user in response to the provision request.

In the present embodiment, the incentive may be, for example, giving cash, or granting points that can be used at a store cooperating with the business operator who operates the server apparatus 100. However, the examples are not limited thereto and the incentive may be anything as long as it is beneficial to the first user.

Topcoat Painting

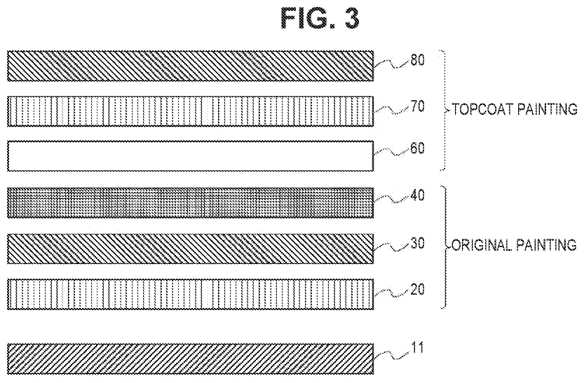

Here, the painting applied on the first vehicle 10 will be described. FIG. 2 is a diagram illustrating a schematic configuration of the painting film applied on the first vehicle 10. As illustrated in FIG. 2, the original painting is applied on the surface of a steel plate 11 composing the body of the first vehicle 10, and the topcoat painting is applied on the original painting. The original painting includes an intermediate coat layer 20 formed on the surface of the steel plate 11, a base layer 30 formed on the intermediate coat layer 20, and a clear layer (the topcoat) 40 formed on the base layer 30. The steel plate 11 is undercoated with an electrodeposition layer. Further, when a member composing the body of the first vehicle 10 is made of resin, a primer layer may be formed instead of the intermediate coat layer 20 of the original painting. Since a special solution, such as a release agent, is needed to peel off the original painting formed as above, it is difficult to easily peel off the original painting.

Next, the topcoat painting includes a peeling layer 50 formed on the original painting (on the clear layer 40). The peeling layer 50 is a layer of an easily peeling paint and has a property of being easily peeled off by applying a force. The peeling layer 50 exemplified in FIG. 2 is an example of the “painting film that includes the easily peeling layer (the first painting film)” according to the present disclosure. Such a peeling layer 50 is formed by applying the easily peeling paint on the original painting using, for example, a spraying method. The easily peeling paint is a paint that includes, for example, xylene, ethylbenzene, an antioxidant, methyl ethyl ketone, a silica reactant, titanium oxide (nanoparticles), and an organic solvent. A clear layer may be formed on the peeling layer 50.

The topcoat painting illustrated in FIG. 2 has a peeling property in the paint itself, but a composition of the topcoat painting is not limited to the example of FIG. 2, and any painting film having an easy peeling property may be used. For example, as illustrated in FIG. 3, a peeling layer 60 may be formed on the clear layer 40 of the original painting, and a base layer 70 and a clear layer 80 may be formed on the peeling layer 60. The peeling layer 60 illustrated in FIG. 3 is formed without coloring, using the same material as that of the peeling layer 50 in FIG. 2. In that case, the peeling layer 60 is one example of the “easily peeling layer” according to the present disclosure, and the topcoat painting including the peeling layer 60, the base layer 70, and the clear layer 80 is one example of the “the painting film that includes the easily peeling layer (the first painting film)” according to the present disclosure. The topcoat painting illustrated in FIG. 3 can be easily peeled off from the original painting by applying a force to the peeling layer 60.

Using the topcoat painting, it is easy to change the body color of the first vehicle 10 to a color different from that of the original painting. Further, by peeling off the topcoat painting, it is also easy to return the body color of the first vehicle 10 to the color of the original painting. Therefore, when purchasing the first vehicle 10, an original painting having a color that is popular in the used car market and the like can be selected, and then a topcoat painting having a color different from that of the original painting can be applied for use of the first vehicle 10. Then, when selling the first vehicle 10 in the used car market and the like, by peeling off the topcoat painting, it is possible to return to the original painting having a color that is popular in the used car market and the like.

However, since it is easier to peel off the topcoat painting than the original painting, it is also assumed that the topcoat painting is peeled off while the first vehicle 10 is being used. Further, it is also assumed that the user intentionally peels off the topcoat painting. In these cases, it is desirable to execute the processing of appropriately disposing of the topcoat painting peeled off from the first vehicle 10.

System Configuration

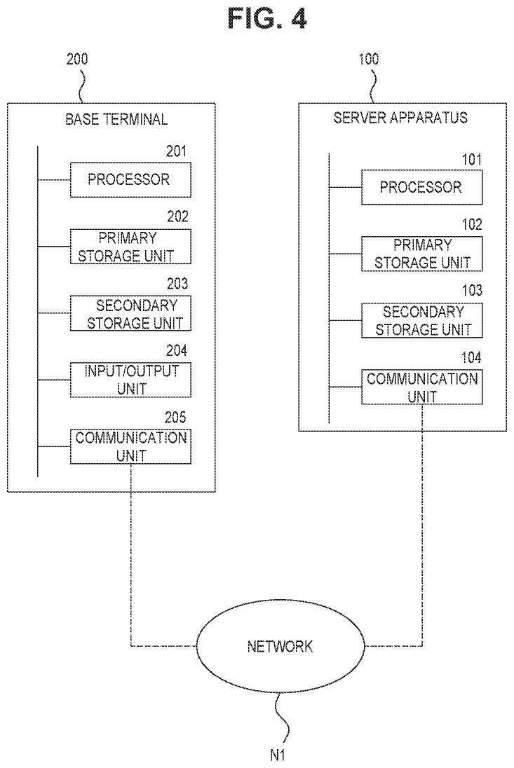

FIG. 4 is a diagram illustrating hardware configuration examples of the server apparatus 100 and the base terminal 200 included in the vehicle management system according to the present embodiment.

The server apparatus 100 is a computer operated by the business operator and the like who manage the first vehicle 10 on which the topcoat painting is applied. As illustrated in FIG. 4, the server apparatus 100 includes a processor 101, a primary storage unit 102, a secondary storage unit 103, and a communication unit 104. The processor 101, the primary storage unit 102, the secondary storage unit 103, and the communication unit 104 are connected to each other via buses. The hardware configuration of the server apparatus 100 is not limited to the example illustrated in FIG. 4, and components may be omitted, replaced, or added as appropriate.

The processor 101 controls the server apparatus 100 by executing arithmetic processing of various pieces of information. Such a processor 101 is composed of, for example, a central processing unit (CPU) or a digital signal processor (DSP).

The primary storage unit 102 is a storage device used as a recording area into which a program stored in the secondary storage unit 103 is loaded, or as a buffer that temporarily stores a calculation result or the like of the processor 101. Such a primary storage unit 102 includes, for example, a semiconductor memory, such as a read-only memory (ROM) and a random access memory (RAM).

The secondary storage unit 103 stores, for example, a program to be executed by the processor 101, and data used when the processor 101 executes the program. Such a secondary storage unit 103 includes, for example, an erasable programmable ROM (EPROM) or a hard disk drive (HDD). The secondary storage unit 103 may include a removable medium. The removable medium may be, for example, a disc recording medium, such as a compact disc (CD) or a digital versatile disc (DVD), or may be a universal serial bus (USB) memory. In addition to an operating system (OS), the program stored in the secondary storage unit 103 includes an application program on the assessment of an incentive. A part or all of the information stored in the secondary storage unit 103 may be stored in the primary storage unit 102.

The communication unit 104 is a communication interface used for connecting the server apparatus 100 to a network N1. The communication unit 104 is connected to the network N1 using, for example, a communication network, such as a local area network (LAN). The communication unit 104 may be connected to the network N1 using a wireless communication network, such as Wi-Fi (registered trademark). The communication unit 104 communicates with other apparatuses (for example, a base terminal 200) via the network N1.

The network N1 may be, for example, a wide area network (WAN), which is a global public communication network, such as the Internet, or other communication networks. The network N1 may include a telephone communication network, such as a mobile phone, or a wireless communication network, such as Wi-Fi (registered trademark).

Next, the base terminal 200 is a computer used by the employee of the predetermined base at which the work of taking over the topcoat painting peeled off from the first vehicle 10 is executed. The base terminal 200 may be a stationary computer installed in the predetermined base, or a tablet computer that can be carried by the employee of the predetermined base. As illustrated in FIG. 4, the base terminal 200 includes a processor 201, a primary storage unit 202, a secondary storage unit 203, an input/output unit 204, and a communication unit 205. The processor 201, the primary storage unit 202, the secondary storage unit 203, the input/output unit 204, and the communication unit 205 are connected to each other via buses. The hardware configuration of the base terminal 200 is not limited to the example illustrated in FIG. 4, and components may be omitted, replaced, or added as appropriate.

Here, since the processor 201, the primary storage unit 202, the secondary storage unit 203, and the communication unit 205 are the same as the processor 101, the primary storage unit 102, the secondary storage unit 103, and the communication unit 104 of the server apparatus 100, description thereof will be omitted. However, the communication unit 205 may be configured to be connected to the network N1 using a mobile communication service, such as Fifth Generation (5G) or Long-Term Evolution (LTE).

The input/output unit 204 receives an input operation executed by the employee of the predetermined base and presents information to the employee. The input/output unit 204 includes, for example, a keyboard and a control circuit thereof, and a liquid crystal display and a control circuit thereof. Instead of the keyboard and the liquid crystal display, the input/output unit 204 may include a touch panel display.

The base terminal 200 configured as above has a function of implementing interaction with the employee. For example, the base terminal 200 implements a function of receiving the input of the first information by the employee, a function of providing the received first information to the server apparatus 100, and a function of presenting a provision request received from the server apparatus 100 to the employee. These functions are implemented by a browser operating in the base terminal 200 or an application program stored in the secondary storage unit 203. A part or all of the functions implemented in the base terminal 200 may be implemented by a hardware circuit, such as an application-specific integrated circuit (ASIC) or a field-programmable gate array (FPGA).

Functional Configuration of Server Apparatus

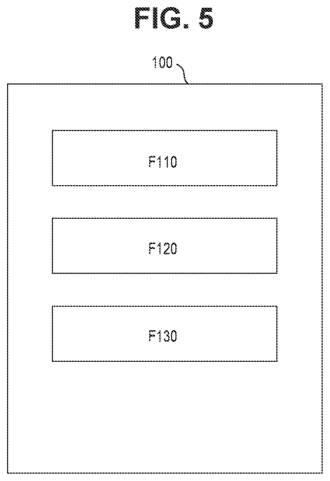

Here, a functional configuration of the server apparatus 100 will be described with reference to FIG. 5. The server apparatus 100 in the present embodiment may be configured to be capable of implementing a web server used for executing interaction with the base terminal 200. In that case, by accessing the web server through the browser, the base terminal 200 can execute the procedures of taking over the topcoat painting brought by the first user, provide the first information to the server apparatus 100, receive the provision request from the server apparatus 100, and the like. The server apparatus 100 may provide the same services as above using equipment other than the web server. For example, the server apparatus 100 may execute processing of implementing interaction with the base terminal 200 using a predetermined protocol and the application program installed in the base terminal 200.

As illustrated in FIG. 5, the server apparatus 100 that implements the above functions includes, as functional components, an acquisition unit F110, a calculation unit F120, and a request unit F130. Functions of the acquisition unit F110, the calculation unit F120, and the request unit F130 are implemented when the processor 101 executes a program stored in the secondary storage unit 103. The processor 101 that implements the functions of the above functional components is an example of the “controller” according to the present disclosure. A part or all of the functions of the acquisition unit F110, the calculation unit F120, and the request unit F130 may be implemented by a hardware circuit, such as an ASIC or an FPGA.

The acquisition unit F110 is one of the functional components used for implementing the above-described web server, and executes interaction with the base terminal 200. For example, when the base terminal 200 accesses, through the browser, a predetermined webpage, the acquisition unit F110 causes the base terminal 200 to display, on the browser thereof, an input screen of the first information. Examples of the predetermined webpage include a webpage used for inputting information needed for the procedures of taking over the topcoat painting or a webpage used for inputting information indicating that the procedures of taking over the topcoat painting are completed. As described above, the first information includes the information on the weight (the first weight) of the topcoat painting brought to the predetermined base and information on the area of the part (the first part) from which the topcoat painting has been peeled off in the first vehicle 10. When the first information is input on the input screen, the acquisition unit F110 acquires the input first information. The first information acquired by the acquisition unit F110 is transferred from the acquisition unit F110 to the calculation unit F120.

The calculation unit F120 calculates the incentive to be provided to the first user based on the first information. The calculation unit F120 of the present embodiment calculates, based on the area of the first part included in the first information, the weight of the topcoat painting estimated to have been applied on the first part (the first estimation value). For example, the calculation unit F120 may calculate the first estimation value based on the area of the first part and a weight of the topcoat painting brought to the predetermined base per unit area. Upon calculating the first estimation value by such a method, the calculation unit F120 calculates the incentive based on the ratio (hereinafter, sometimes referred to as a “first ratio”) of the first weight to the first estimation value. In that case, the calculation unit F120 calculates the incentive by a method in which the incentive to be provided to the first user becomes higher as the first ratio is greater.

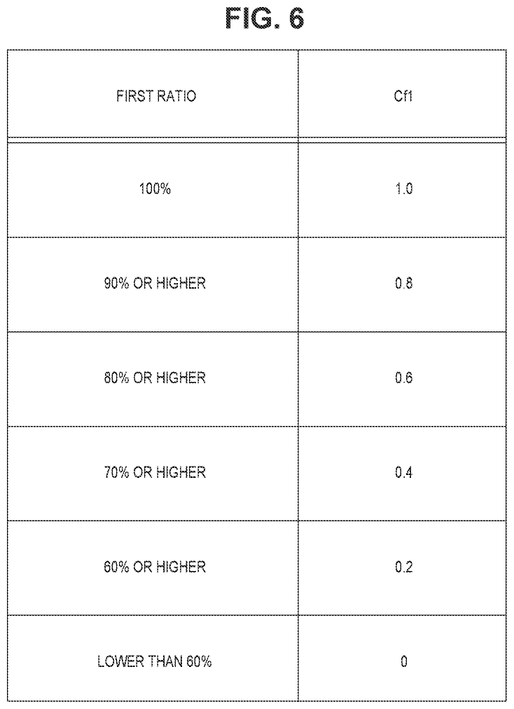

For example, the calculation unit F120 first determines a coefficient Cf1 based on a correspondence relationship as illustrated in FIG. 6. As illustrated in FIG. 6, the coefficient Cf1 is a positive number of 1.0 or smaller, and is set such that its value becomes higher as the first ratio is greater. In an example illustrated in FIG. 6, when the first ratio is smaller than 60%, the coefficient Cf1 is set to “0”. On the other hand, when the first ratio is 60% or greater, the coefficient Cf1 is set to become higher as the first ratio is greater, and when the first ratio is 100% (when the first weight is equal to the first estimation value), the coefficient Cf1 is set to become the maximum of 1.0. The correspondence relationship as illustrated in FIG. 6 may be stored in the secondary storage unit 103 in the form of a map, or may be stored in the secondary storage unit 103 in the form of a calculation model. Further, numerical values of the first ratio and values of the coefficient Cf1 illustrated in FIG. 6 are merely examples and are not limited to the examples of FIG. 6.

When the coefficient Cf1 is determined by the method as above, the calculation unit F120 calculates the incentive to be provided to the first user by multiplying a reference value Icdef of the incentive by the coefficient Cf1. The reference value Icdef is an upper limit value of the incentive, and corresponds to a value (an amount of money, a point, or the like) of the incentive to be provided when the first weight is equal to the first estimation value. When the first ratio is 60% or greater, the incentive calculated in this manner becomes higher as the first ratio is greater. On the other hand, when the first ratio is smaller than 60%, the incentive to be provided to the first user becomes “0” (the incentive is not provided to the first user). The incentive calculated by the calculation unit F120 is transferred from the calculation unit F120 to the request unit F130.

The calculation method of the incentive is not limited to the above method, and any method may be used as long as it is a calculation method in which the incentive becomes higher as the first weight is closer to the first estimation value. For example, the incentive may be calculated by a method in which the incentive becomes higher as a difference between the first weight and the first estimation value is smaller.

Here, returning to FIG. 5, in the same manner as the acquisition unit F110, the request unit F130 is one of the functional components used for implementing the above-described web server, and executes interaction with the base terminal 200. For example, the request unit F130 causes the base terminal 200 to display, on the browser thereof, the provision request. The provision request at that time includes, for example, the incentive calculated by the calculation unit F120 and a message prompting the employee of the predetermined base to provide the incentive to the first user. The employee who sees such a provision request can provide the incentive calculated by the calculation unit F120 to the first user.

The functional configuration of the server apparatus 100 is not limited to the example illustrated in FIG. 5, and functional components can be omitted, replaced, or added as appropriate.

Flows of Processing

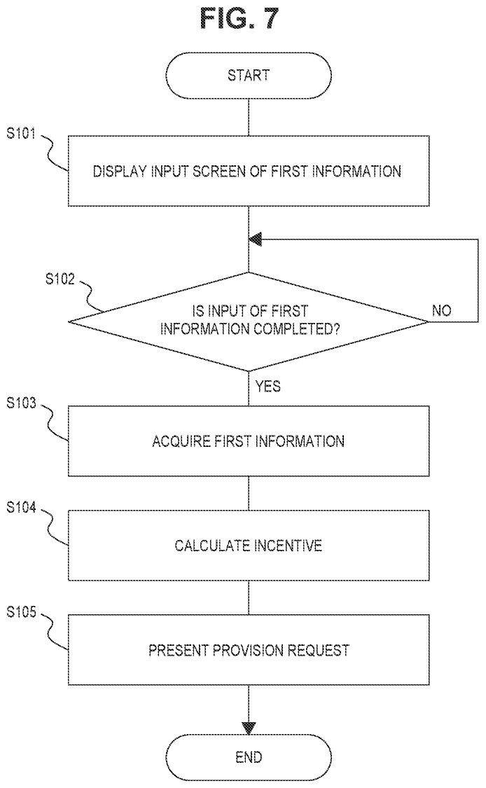

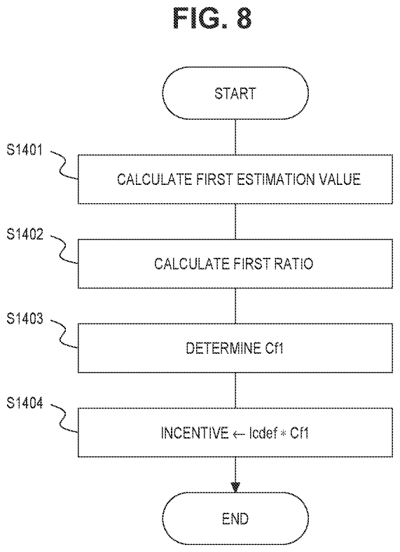

Flows of processing executed in the server apparatus 100 in the present embodiment will be described with reference to FIGS. 7 and 8. FIG. 7 is a flowchart illustrating a processing routine executed when the base terminal 200 accesses the above-described predetermined web page through the browser. FIG. 8 is a flowchart illustrating a subroutine executed in step S104 in FIG. 7. A subject that executes the processing illustrated in FIGS. 7 and 8 is the processor 101 of the server apparatus 100, but here, the description will be made by setting the functional component of the server apparatus 100 as the subject.

When the base terminal 200 accesses the above-described predetermined web page through the browser, as illustrated in FIG. 7, the acquisition unit F110 causes the base terminal 200 to display, on the browser thereof, the input screen of the first information (step S101). Upon ending the execution of the process of step S101, the acquisition unit F110 executes a process of step S102.

In step S102, the acquisition unit F110 determines whether the input of the first information on the input screen of the first information is completed. When the input of the first information on the input screen of the first information is not completed (a negative determination in step S102), the acquisition unit F110 stands by until the input of the first information is completed. On the other hand, when the input of the first information on the input screen of the first information is completed (a positive determination in step S102), the acquisition unit F110 executes a process of step S103.

In step S103, the acquisition unit F110 acquires the first information that is input on the input screen of the first information. The first information acquired by the acquisition unit F110 is transferred from the acquisition unit F110 to the calculation unit F120. Upon receiving the first information, the calculation unit F120 executes a process of step S104.

In step S104, the calculation unit F120 calculates the incentive to be provided to the first user based on the first information received from the acquisition unit F110. At that time, the calculation unit F120 calculates the incentive to be provided to the first user according to the subroutine of FIG. 8.

In FIG. 8, the calculation unit F120 calculates the first estimation value based on the first information received from the acquisition unit F110 (step S1401). For example, the calculation unit F120 calculates the first estimation value by multiplying the area of the first part included in the first information by the weight of the topcoat painting brought to the predetermined base per unit area. Upon ending the execution of the process of step S1401, the calculation unit F120 executes a process of step S1402.

In step S1402, the calculation unit F120 calculates the first ratio by dividing the first weight included in the first information by the first estimation value calculated in step S1401. Upon ending the execution of the process of step S1402, the calculation unit F120 executes a process of step S1403.

In step S1403, the calculation unit F120 determines the coefficient Cf1 based on the first ratio calculated in step S1402. For example, the calculation unit F120 determines the coefficient Cf1 based on the first ratio and the above-described correspondence relationship illustrated in FIG. 6. Upon ending the execution of the process of step S1403, the calculation unit F120 executes a process of step S1404.

In step S1404, the calculation unit F120 calculates the incentive to be provided to the first user by multiplying the reference value Icdef of the incentive by the coefficient Cf1 determined in step S1403. When the calculation unit F120 ends the execution of the process of step S1404, the execution of the subroutine of FIG. 8 ends.

Here, returning to the processing routine of FIG. 7, the calculation unit F120 transfers the incentive calculated in step S104 (steps S1401 to S1404) to the request unit F130. Upon receiving the incentive calculated by the calculation unit F120, the request unit F130 executes a process of step S105.

In step S105, the request unit F130 presents the provision request to the employee of the predetermined base. Specifically, the request unit F130 causes the base terminal 200 to display, on the browser thereof, the provision request. As described above, the provision request is a request for providing the incentive calculated in the server apparatus 100 to the first user. When such a provision request is displayed on the base terminal 200, the employee who sees the provision request can provide the incentive calculated in the server apparatus 100 to the first user.

When the request unit F130 ends the execution of the process of step S105, the execution of the processing routine of FIG. 7 ends.

### Advantageous Effect of Embodiments

With the above-described embodiment, the incentive is provided to the first user who brings, to the predetermined base, a topcoat painting of which a weight is a weight where the first ratio is 60% or greater, from among the topcoat paintings peeled off from the first vehicle 10. In other words, the first user can receive the incentive in return for bringing, to the predetermined base, a topcoat painting of which a weight is a weight where the first ratio is 60% or greater from among the topcoat paintings peeled off from the first vehicle 10. As such, it is possible to motivate the first user to bring, to the predetermined base, the topcoat painting of which a weight is a weight where the first ratio is 60% or greater from among the topcoat paintings peeled off from the first vehicle 10.

Further, when the first ratio is 60% or greater, the incentive to be provided to the first user becomes higher as the first ratio is greater. Thus, it is possible to motivate the first user to bring, to the predetermined base, more topcoat paintings from among the topcoat paintings peeled off from the first vehicle 10.

Therefore, it is possible to further increase amounts of the topcoat paintings brought to the predetermined base from among the topcoat paintings peeled off from the first vehicle 10. As a result, it is possible to increase the amounts of topcoat paintings that are appropriately disposed of as many as possible from among the topcoat paintings peeled off from the first vehicle 10.

### Modified Example

In the above-described embodiment, an example where the incentive to be provided to the first user is determined based on the first information is described. On the other hand, in addition to the first information, the incentive to be provided to the first user may be determined based on the presence or absence of additional information provided from the first user.

Here, the additional information is information effective for accurately assessing the incentive, assessing the resale value of the first vehicle 10, managing a history of the topcoat painting of the first vehicle 10, improving the topcoat painting, or the like. Examples of such additional information can include the following information:

(1) Images of the first vehicle 10 before and after the topcoat painting has been peeled off

(2) An image of the original painting in the part from which the topcoat painting has been peeled off

(3) A timing at which the topcoat painting has been peeled off

(4) A reason why the topcoat painting has been peeled off

(5) A method of peeling off the topcoat painting when the first user has intentionally peeled off the topcoat painting

(6) A time needed for peeling off the topcoat painting when the first user has intentionally peeled off the topcoat painting

When the additional information is (1), it is possible to specify the region from which the topcoat painting has been peeled off in the first vehicle 10 by executing image processing of the images of the first vehicle 10 before and after the topcoat painting has been peeled off. As such, it is also possible to manage the history on the topcoat painting of the first vehicle 10. Further, by comparing the images of the first vehicle 10 before and after the topcoat coating has been peeled off, it is possible to check whether the area of the part (the first part) from which the topcoat painting has been peeled off matches the area provided in the first information. Further, it is also possible to, for example, more accurately determine whether the topcoat painting brought to the predetermined base by the first user has been peeled off from the first vehicle 10. As a result, it is also possible to more accurately assess the incentive to be provided to the first user.

Further, when the additional information is (2), it is also possible to more accurately manage the state of the original painting of the first vehicle 10. As a result, when, for example, selling or returning the first vehicle 10, it is possible to more accurately assess the resale value of the first vehicle 10.

Further, when the additional information is (3), it is possible to more accurately manage the history on the topcoat painting of the first vehicle 10.

Further, when the additional information is (4), it is possible to more accurately grasp the cause and the like of the peeling-off of the topcoat painting while the first vehicle 10 is being used. As such, it is also possible to specify by what cause the topcoat painting can be peeled off except when the first user has intentionally peeled off the topcoat painting, and execute, for example, an improvement of the topcoat painting according to the specified cause.

Further, when the additional information is (5), it is also possible to manage how the topcoat painting applied on the first vehicle 10 has been peeled off.

Further, when the additional information is (6), it is also possible for a general user to grasp the time needed for peeling off the topcoat painting with his/her own hands.

Therefore, the incentive may be calculated by a method in which the incentive to be provided to the first user becomes higher when the first user provides at least one piece of pieces of the additional information (1) to (6) to the employee of the predetermined base than when the first user does not provide any additional information.

For example, the calculation unit F120 first calculates the incentive based on the first ratio, as described in the above-described embodiment. Subsequently, the calculation unit F120 may multiply the incentive, which is calculated based on the first ratio, by a correction coefficient according to the presence or absence of the additional information provided from the first user. The correction coefficient in that case may be set such that its value becomes higher when additional information provided from the first user is present than when additional information is absent. For example, the correction coefficient when additional information provided from the first user is absent may be set to “1.0”, and the correction coefficient when additional information provided from the first user is present may be set to “1.5”.

The method of correcting the incentive, which is calculated based on the first ratio, is not limited to the above method. For example, the incentive, which is calculated based on the first ratio, may be corrected according to the type, number, or the like of additional information provided from the first user. For example, the incentive, which is calculated based on the first ratio, may be corrected such that the incentive to be provided to the first user becomes higher as the number of pieces of additional information provided from the first user is larger. Further, the incentive, which is calculated based on the first ratio, may be corrected using the correction coefficient that is set for each type of additional information provided from the first user.

When the incentive is determined by the above method, it is possible to motivate the first user to provide the additional information to the employee of the predetermined base in addition to motivating the first user to bring the topcoat painting peeled off from the first vehicle 10 to the predetermined base.

Others

The above embodiment and the modified example are merely examples, and the present disclosure can be appropriately modified and implemented within a range not departing from the gist thereof. For example, a part or all of the processes executed in the server apparatus 100 may be executed in other apparatuses (for example, the base terminal 200).

Further, the processes and elements described in the present disclosure can be freely combined and executed within a range in which no technical contradiction arises.

Further, the processes described as being executed by one device may be executed in a shared manner by a plurality of devices. Alternatively, the processes described as being executed by different devices may be executed by one device. In a computer system, the hardware configuration that implements each function can be flexibly changed.

Further, the present disclosure can also be implemented by supplying a computer with a computer program (an information processing program) that implements the functions described in the above embodiment, and by reading and executing the program by one or more processors included in the computer. Such a computer program may be provided to a computer by a non-transitory computer-readable storage medium that can be connected to a system bus of the computer, or may be provided to the computer via a network. The non-transitory computer-readable storage medium is a recording medium that can accumulate information, such as data and programs by electrical, magnetic, optical, mechanical, or chemical action, and can be read by a computer or the like. Examples of such a recording medium can include any type of disk, such as a magnetic disk (a Floppy® disk, an HDD, or the like), and an optical disk (a CD-ROM, a DVD disk, a Blu-ray disk, or the like). Further, the recording medium may be a medium, such as a ROM, a RAM, an EPROM, an EEPROM, a magnetic card, a flash memory, an optical card, or a solid state drive (SSD).

What is claimed is:

1. An information processing apparatus comprising:
a controller configured to execute first processing of providing an incentive to a first user who brings a first painting film to a predetermined base, the first painting film being a painting film including an easily peeling layer and that is peeled off from a first vehicle.

2. The information processing apparatus according to claim 1, wherein the first processing includes:
acquiring first information including information on a first weight, the first weight being a weight of the first painting film brought to the predetermined base; and
calculating the incentive to be provided to the first user based on the first information.

3. The information processing apparatus according to claim 2, wherein:
the first information includes information on the first weight and information on a size of a first part, the first part being a part from which the first painting film is peeled off in the first vehicle; and
the controller is configured to:
calculate, based on the size of the first part, a first estimation value, the first estimation value being a weight of the first painting film estimated to have been applied on the first part; and
calculate the incentive such that the incentive becomes higher as a ratio of the first weight to the first estimation value is greater.

4. The information processing apparatus according to claim 3, wherein:
the controller is configured to correct the incentive that is calculated based on the first information such that the incentive becomes higher when the first user provides additional information to the predetermined base than when the first user does not provide the additional information; and
the additional information is information on peeling-off of the first painting film from the first vehicle.

5. The information processing apparatus according to claim 4, wherein the additional information includes an image of the first vehicle before the first painting film is peeled off and an image of the first vehicle after the first painting film is peeled off.

6. The information processing apparatus according to claim 4, wherein the additional information includes an image of an original painting in a part from which the first painting film is peeled off in the first vehicle.

7. The information processing apparatus according to claim 4, wherein the additional information includes information on a timing at which the first painting film is peeled off.

8. The information processing apparatus according to claim 4, wherein the additional information includes information on a reason why the first painting film is peeled off.

9. The information processing apparatus according to claim 4, wherein the additional information includes information on a method of peeling off the first painting film when the first user intentionally peels off the first painting film.

10. The information processing apparatus according to claim 4, wherein the additional information includes information on a time needed for peeling off the first painting film when the first user intentionally peels off the first painting film.

11. An information processing method executed by a computer, the information processing method comprising:
executing first processing of providing an incentive to a first user who brings a first painting film to a predetermined base, the first painting film being a painting film including an easily peeling layer and that is peeled off from a first vehicle.

12. The information processing method according to claim 11, wherein the first processing includes:
acquiring first information including information on a first weight, the first weight being a weight of the first painting film brought to the predetermined base; and
calculating the incentive to be provided to the first user based on the first information.

13. The information processing method according to claim 12, wherein:
the first information includes information on the first weight and information on a size of a first part, the first part being a part from which the first painting film is peeled off in the first vehicle;
the first processing includes
calculating a first estimation value based on the size of the first part, the first estimation value being a weight of the first painting film estimated to have been applied on the first part, and
calculating the incentive such that the incentive becomes higher as a ratio of the first weight to the first estimation value is greater.

14. The information processing method according to claim 13, wherein the first processing includes correcting the incentive that is calculated based on the first information such that the incentive to be provided to the first user becomes higher when the first user provides additional information on peeling-off of the first painting film from the first vehicle to the predetermined base than when the first user does not provide the additional information.

15. The information processing method according to claim 14, wherein the additional information includes an image of the first vehicle before the first painting film is peeled off and an image of the first vehicle after the first painting film is peeled off.

16. The information processing method according to claim 14, wherein the additional information includes an image of an original painting in a part from which the first painting film is peeled off in the first vehicle.

17. The information processing method according to claim 14, wherein the additional information includes information on a timing at which the first painting film is peeled off.

18. The information processing method according to claim 14, wherein the additional information includes information on a reason why the first painting film is peeled off.

19. The information processing method according to claim 14, wherein the additional information includes information on a method of peeling off the first painting film when the first user intentionally peels off the first painting film.

20. A non-transitory storage medium that causes the computer to execute the information processing method according to claim 11.
